(19) United States
(12) Patent Application Publication
(10) Pub. No.: US 2020/0313267 A1
(43) Pub. Date: Oct. 1, 2020

(54) Modular Microwave Choke Assembly

(71) Applicant: Marion Process Solutions, Inc., Marion, IA (US)

(72) Inventors: Dale K. Schumann, Marion, IA (US); Wesley M. Dautremont, Lexington, KY (US)

(73) Assignee: Marion Process Solutions, Inc.

(21) Appl. No.: 16/829,030

(22) Filed: Mar. 25, 2020

Related U.S. Application Data
(60) Provisional application No. 62/827,717, filed on Apr. 1, 2019.
(60) Provisional application No. 62/834,055, filed on Apr. 15, 2019.

(51) Int. Cl. H01P 1/22

(52) U.S. Cl. CPC H01P 1/22; F16C 33/74

(57) ABSTRACT

A modular microwave choke assembly for attenuating microwave energy along a rotating shaft. The choke assembly generally includes a plurality of choke rings connected together, the plurality of choke rings positioned and shaped to surround a portion of a shaft that extends out of a microwave chamber, wherein each choke ring creates a high-impedance zone adjacent to the portion of the shaft surrounded by each choke ring. The plurality of choke rings are spaced apart from each other along the shaft. A plurality of gaps are formed between the plurality of choke rings, along the shaft, wherein the gaps are created by the spaces between the plurality of choke rings. The choke rings and the gaps create alternating high-impedance and low-impedance zones along the shaft that attenuate microwave energy.

### CROSS REFERENCE TO RELATED APPLICATIONS

I hereby claim benefit under Title 35, United States Code, Section 119(e) of U.S. provisional patent application Ser. No. 62/827,717 filed Apr. 1, 2019. The 62/827,717 application is currently pending. The 62/827,717 application is hereby incorporated by reference into this application.

I hereby claim benefit under Title 35, United States Code, Section 119(e) of U.S. provisional patent application Ser. No. 62/834,055 filed Apr. 15, 2019. The 62/834,055 application is currently pending. The 62/834,055 application is hereby incorporated by reference into this application.

### STATEMENT REGARDING FEDERALLY SPONSORED RESEARCH OR DEVELOPMENT

Not applicable to this application.

### BACKGROUND

### Field

Example embodiments in general relate to a modular microwave choke assembly for maintaining safe levels of microwave leakage from a microwave cavity.

### Related Art

Any discussion of the related art throughout the specification should in no way be considered as an admission that such related art is widely known or forms part of common general knowledge in the field.

Methods and equipment are known for sealing a microwave cavity to prevent leakage of microwaves in order to keep people near the cavity safe. Such seals are typical where a door can be closed. However, sealing openings in cavities that may not be designed the same way as door seals, such as those with rotating shafts, may also be necessary.

### SUMMARY

An example embodiment is directed to a modular microwave choke assembly. The modular microwave choke assembly is useful for sealing a shaft, such as a cylindrical, rotating shaft, or other protrusion that extends through the wall of a microwave chamber, to contain the microwave energy within the chamber, or reduce its strength to safe levels where the shaft extends through the wall. The assembly may be used, for example, to seal the shaft of a horizontal mixer that also uses microwaves to dry powder or other material being processed, in addition to other uses. The assembly includes or creates an alternating series of zones that present high impedance and low impedance to microwaves along the length of the shaft, such that a portion of the shaft is adjacent to each alternating high or low impedance zone. For example, the first high-impedance zone may have a corresponding first portion of the shaft adjacent to it, and the second high impedance zone may have a corresponding second portion of the shaft adjacent to it. The modular microwave choke assembly may comprise a central opening through which the shaft passes, from one end near the chamber, to the opposite end, and each modular choke component may comprise a central opening though which the shaft passes.

One possible example modular microwave choke assembly generally comprises a mount choke ring for mounting the assembly on the wall or a mounting flange of a chamber that may receive microwave energy. The mount choke ring has a central opening through which a rotating or stationary shaft may extend, and the opening of the mount choke ring may have a choke ring flange that extends away from the wall of the microwave chamber. The mount choke ring and other choke rings that make up the assembly may have a cross section that is generally L-shaped, with a disc portion corresponding to the vertical part of the “L”, and a flange portion corresponding to the horizontal part, the flange portion being cylindrical on its interior, and having a side opposite the interior, so that the flange portion comprises a circumferential wall adjacent to, and substantially surrounding, the shaft. The choke rings may be made of a material, such as metal (e.g., stainless steel or brass, etc.) that presents a high-impedance to microwaves. Between each of the multiple choke ring flange portions, there may be a gap along the length of the shaft, so that the mount choke ring or other choke rings do not surround the shaft along the entire length of the assembly. These gaps may comprise low-impedance zones, and may be filled with choke inserts, made from material that is transparent, or nearly transparent, to microwaves. In addition, the outer circumference of the assembly may include portions of the choke rings, or separate choke spacer rings, that are made of a material, such as metal, that also presents high impedance to microwaves. Thus, the assembly may include low-impedance cavities (for example, somewhat rectangular cavities viewed in cross section) in the shape of rings around the shaft, positioned between the high-impedance portions of the choke ring flanges. As mentioned, the cavities may be filled with choke inserts made of a material, such as PTFE, that is substantially transparent to (but which may slow or attenuate) microwaves. In an example embodiment, the mount choke ring may be mounted directly on the wall of the chamber, or it may be mounted on a mounting flange in the form of a ring that adds rigidity and provides for a seal or seals along the shaft. The assembly may include any number of choke rings and choke inserts, with more rings and inserts resulting in greater attenuation of microwave energy along the shaft, away from the microwave cavity. As the name suggests, the assembly is modular, meaning that the choke rings and choke inserts are, or can be, physically identical or similar enough so that additional parts may simply be stacked together to create an assembly with greater attenuation, without the need to create additional, physically different parts. After the final choke insert is installed, the assembly may include a final choke ring, or a choke ring cap, which may be physically different from the intermediate choke rings, although in some embodiments it may be the same. In an embodiment where the choke ring cap is not identical to the choke rings, the assembly can comprise a mount choke ring, any number of identical or similar intermediate choke rings and choke inserts, and a choke ring cap to contain the assembly, through which the shaft may extend, beyond the assembly.

In another possible embodiment, the assembly also includes a mount choke ring which creates the first high-impedance zone next to the chamber, as with the previous embodiment. Further, the mount choke ring and choke ring and choke ring cap may not have L-shaped flanges, but simply extend toward the opening of the assembly in disc form. As with other embodiments, the assembly is attached to the wall of the chamber by a mounting flange. Also as with other embodiments, the components of this example embodiment are modular, and so may be stacked together in different numbers to create a different number of alternating high-impedance zones and low-impedance zones. The choke inserts may have a different, simpler shape than those of the previous embodiment, but still define substantially rectangular cross section shapes, which in three dimensions are in the shape of flattened rings.

This embodiment does not require separate spacers as with other embodiments, but instead relies on the shape of the choke rings themselves to create the cavity into which choke inserts are positioned. This embodiment also includes a number of seals, the first being positioned within an annular channel in mounting flange. A second seal may be positioned in another channel in choke ring cap to prevent material from leaking past the end of the assembly.

Some embodiments may also include an integral bearing, which is attached and mounted on the assembly by screws that pass through bearing spacers, which create a gap between the bearing and the choke ring cap. This gap allows any material that gets past the seals to fall into the gap, preventing contamination of the bearing. As with other embodiments, the width of the portion of choke rings next to the shaft may be selected and specifically tuned to attenuate microwaves of any particular frequency, and may also be varied for different rings in the assembly to attenuate different frequencies of microwaves from one zone to another. This may require slightly different components, such as choke inserts having different thicknesses. However, the modular nature, due to the other dimensions and mounting hole spacing, may be retained, so that different numbers of high-impedance zones and low-impedance zones may still be created with a minimal number of different parts, or with the same parts, such as choke rings, choke inserts, etc.

In still other example embodiments, the choke inserts may be sized and shaped to create annular gaps between the choke spacer rings and the outer surfaces of choke ring flanges. In addition, the spacer rings may have fittings for compressed air to be applied. Holes in the choke inserts allow for the passage of compressed air from the inlets through the annular gaps, holes, and holes that pass through the choke ring flanges. Accordingly, compressed air may be used to keep the shaft and the modular microwave choke assembly free of powder or other material being processed in the mixer.

There has thus been outlined, rather broadly, some of the embodiments of the modular microwave choke assembly in order that the detailed description thereof may be better understood, and in order that the present contribution to the art may be better appreciated. There are additional embodiments of the modular microwave choke assembly that will be described hereinafter and that will form the subject matter of the claims appended hereto. In this respect, before explaining at least one embodiment of the modular microwave choke assembly in detail, it is to be understood that the modular microwave choke assembly is not limited in its application to the details of construction or to the arrangements of the components set forth in the following description or illustrated in the drawings. The modular microwave choke assembly is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a modular microwave choke assembly in accordance with an example embodiment.

FIG. 2A is a sectional view of a modular microwave choke assembly in accordance with an example embodiment.

FIG. 2B is another sectional view of a modular microwave choke assembly in accordance with an example embodiment.

FIG. 3 is another sectional view of a modular microwave choke assembly in accordance with an example embodiment.

FIG. 4 is an exploded view of a modular microwave choke assembly in accordance with an example embodiment.

FIG. 5 is a perspective view of a modular microwave choke assembly in accordance with an example embodiment.

FIG. 6 is a sectional view of a modular microwave choke assembly along the line 6-6 from FIG. 5.

FIG. 7 is a detailed sectional view of a modular microwave choke assembly in accordance with an example embodiment.

FIG. 8 is a sectional view of a modular microwave choke assembly in accordance with another example embodiment.

FIG. 9 is a perspective view of a modular microwave choke assembly in accordance with an example embodiment.

FIG. 10 is a sectional view of a modular microwave choke assembly along the line 10-10 from FIG. 9.

FIG. 11 is a sectional view of a modular microwave choke assembly in accordance with another example embodiment.

FIG. 12 is a perspective view of a modular microwave choke assembly in accordance with an example embodiment.

FIG. 13 is a sectional view of a modular microwave choke assembly along the line 13-13 from FIG. 12 in accordance with another example embodiment.

FIG. 14 is a perspective view of a modular microwave choke assembly in accordance with an example embodiment.

FIG. 15 is a sectional view of a modular microwave choke assembly along the line 15-15 from FIG. 14 in accordance with another example embodiment.

FIG. 16 is an exploded view of a modular microwave choke assembly in accordance with another example embodiment.

FIG. 17 is a sectional view of a modular microwave choke assembly in accordance with another example embodiment.

### DETAILED DESCRIPTION

### A. Overview

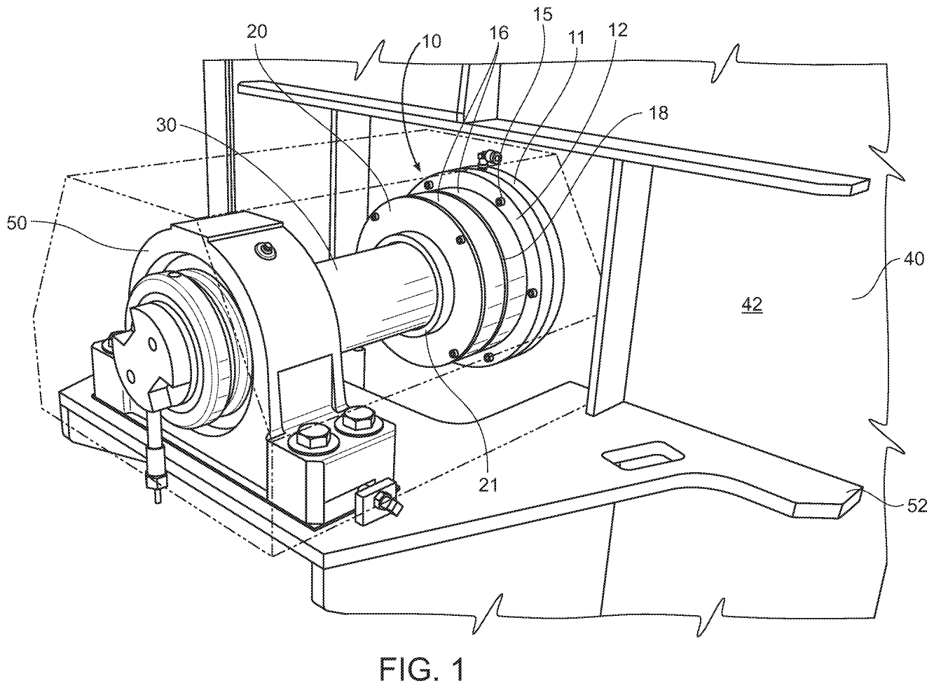

An example modular microwave choke assembly 10 generally comprises a mount choke ring 12 for mounting the assembly 10 on the wall 42 or a mounting flange 11 of a chamber 40 that may receive microwave energy. FIGS. 1-3 illustrate one possible application, and one embodiment, of the modular microwave choke assembly 10. As shown, the assembly 10 is mounted on the wall 42 of a multi-purpose chamber which includes or contains microwave energy. In the embodiment shown, the chamber 40 is a mixing chamber for mixing materials being processed, while also exposing them to microwave energy from microwave cavity 44 and possibly a vacuum while the materials are being mixed. As shown in FIG. 1, the shaft may be supported by a bearing 50 that is separated from the choke assembly 10 by some distance, which is not necessarily critical. The bearing 50 may be securely mounted on a bearing support attached to the chamber 40. In the embodiment shown, the shaft 30 is the shaft of a horizontal mixer, which may have attached to it agitating elements 46, such as mixing paddles, scrapers, etc. As stated, the modular choke assembly 10 seals any material being processed within the chamber 40, preventing loss and leakage where the shaft 30 exits the chamber 40, and the assembly 10 also reduces microwaves to which personnel near the mixer may be exposed, to safe levels.

The mount choke ring 12 has a central opening 32 through which a rotating or stationary shaft 30 may extend, and the opening 32 of the mount choke ring 12 may have a mount choke ring flange portion 26 that extends away from the wall of the microwave chamber 40. The mount choke ring 12 and other choke rings 18 that make up the assembly 10 may have a cross section that is generally L-shaped (viewed in cross section through a plane that intersects the axis of the shaft 30), with a disc portion 27 corresponding to the vertical of the “L”, and a flange portion 26 corresponding to the horizontal part, the flange portion 26 being cylindrical on its interior, with a side opposite the central opening 32.

The mount choke ring 12 may be made of metal, such as stainless steel, brass, or other metal, and thus presents high impedance to microwaves. Extending away from the microwave chamber wall 42, the assembly 10 may include any number of alternating high-impedance zones 22 and low-impedance zones 24, the impedance being with respect to microwaves.

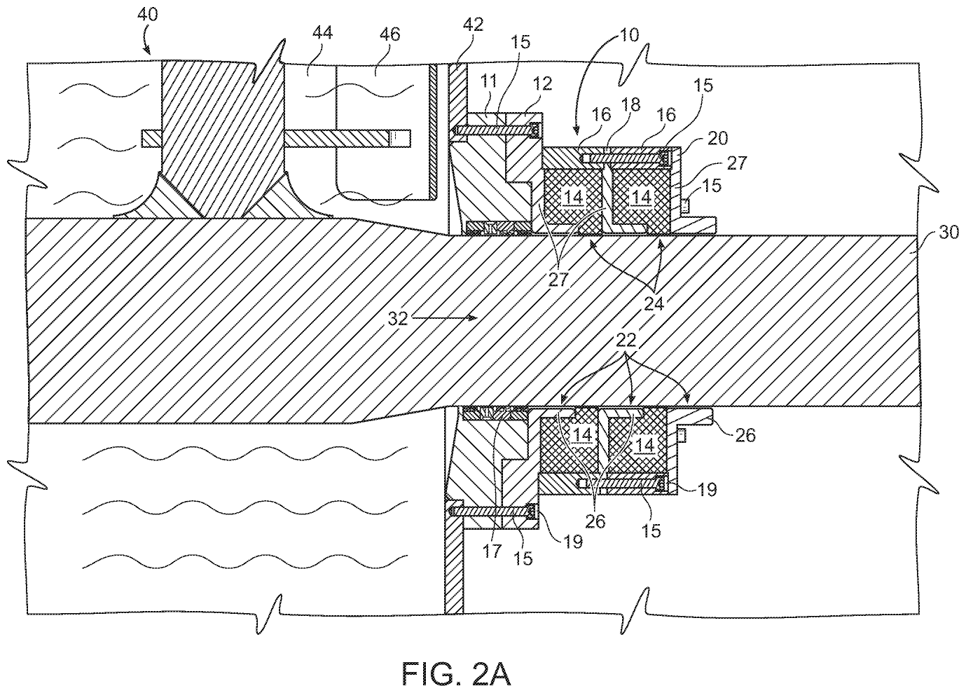

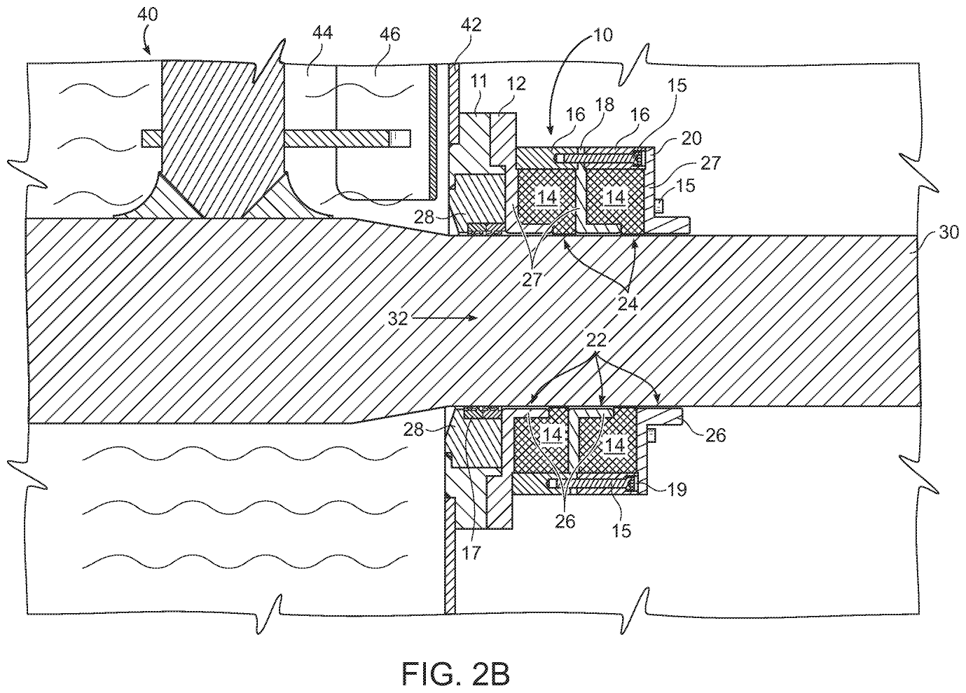

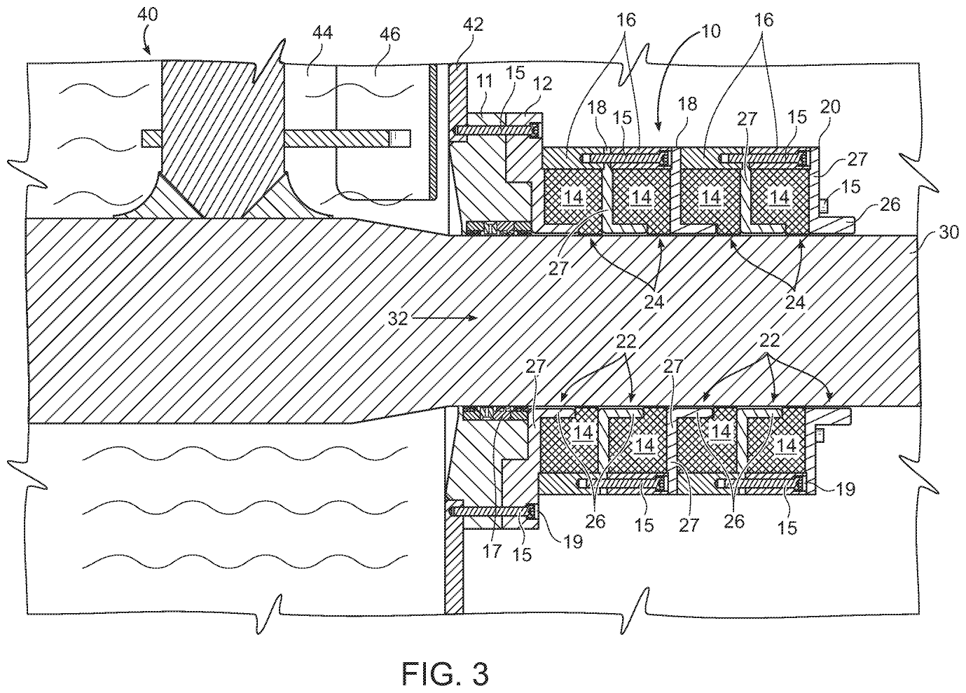

For example, as shown in FIGS. 2A, 2B, and 3, immediately adjacent to the mount choke ring 12, the assembly 10 may include a low-impedance choke insert 14 that is generally ring shaped and fits over the mount choke ring flange portion 26 and that extends down into a space created by the gap between the mount choke ring flange 26 and the next, second choke ring 18 in the assembly 10, which is adjacent to the mount choke ring 12. The choke inserts 14 may be made of Teflon, such as PTFE. The choke inserts 14 may have a fairly tight fit on the shaft 30, to prevent materials from leaking along the shaft 30, and also to prevent material from entering the cavity formed between the choke rings 12, 18. As shown in the Figures, the cavities generally have the same shape and size as inserts 14. Foreign material within the cavity could possibly degrade the performance of the system. In addition, the choke inserts are low impedance, but they do present some impedance to microwaves entering the cavity between choke rings 12, 18, for example. Thus, microwave energy that enters the cavities filled with the inserts 14 will be attenuated.

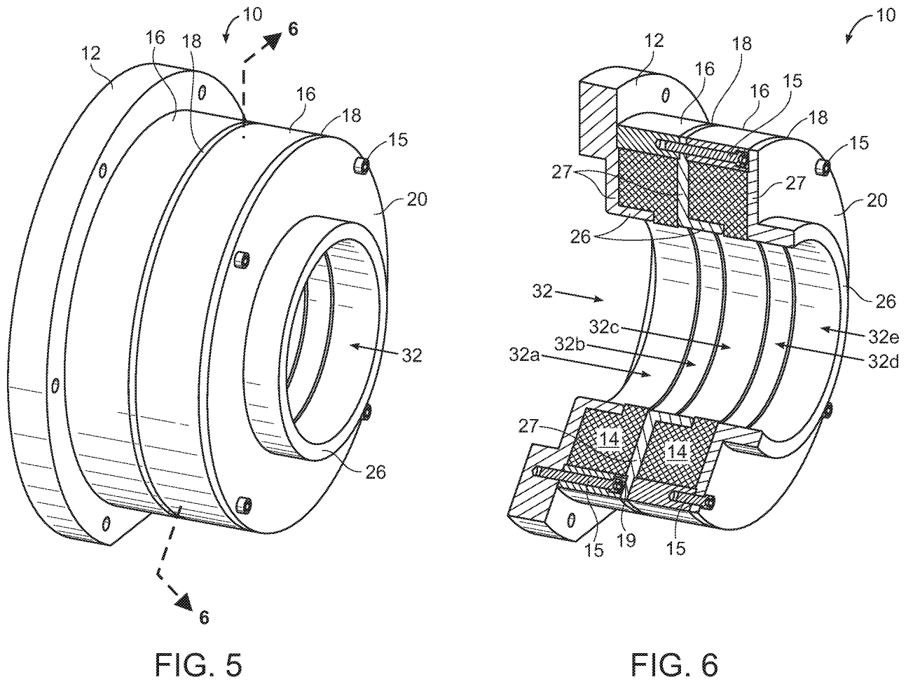

In the embodiment shown in FIGS. 2-7, a spacer 16 in the shape of a ring that forms the outer circumference of the assembly 10 is positioned between the mount choke ring 12 and the second, adjacent choke ring 18 in the assembly, and between each additional choke ring 18. The portion of the assembly 10 described thus far creates a low-impedance zone 24 in the shape of a substantially or somewhat rectangular cavity (viewed in cross section) that is defined by high impedance material, such as steel or other metal. The rectangular cavity is substantially filled with the choke insert material, which is substantially microwave transparent. As denoted in FIG. 6, each modular component comprises a portion of central opening 32. Accordingly, mount choke ring 12 comprises central opening 32a, spacers 14 comprise central openings 32b and 32d, middle choke ring 18 comprises central opening 32c, and choke ring cap 20 comprises central opening 32e. Corresponding openings 32a-32e are also shown in FIG. 10.

Referring to FIGS. 2-3, 8, & 11, the assembly creates alternating high-impedance zones 22 and low-impedance zones 24. These alternating zones tend to attenuate the microwave energy in cavity 44 in each embodiment shown, so that the energy decreases at distances farther from the source, the chamber 40.

### B. High-Impedance and Low-Impedance Zones

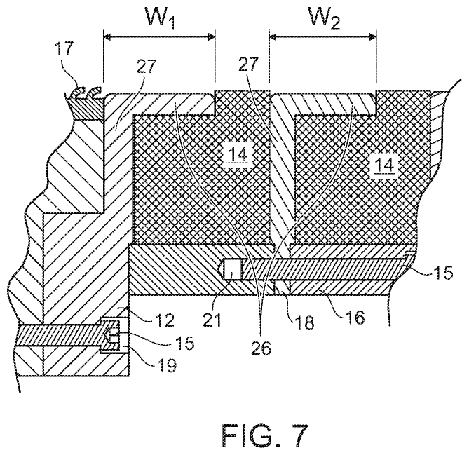

One possible example embodiment is shown in FIGS. 2-7. In this embodiment, the choke rings 12, 18, and the choke ring cap 20, which create the high-impedance zones 22, are L-shaped when viewed in cross section as shown in FIGS. 2A, 2B, and 3, creating a flange portion 26 in the form of a flat ring that extends along and circles the shaft 30, which may pass through opening 32 of the modular microwave choke assembly 10. The vertical portion of the L-shape comprises a disc portion 27. As will be discussed below, the L shape is not critical, and other shapes are also possible. However, in this embodiment, the L shape, combined with the spacing between the choke components 12, 18, and 20, create and define low-impedance cavities that are somewhat rectangular in shape, and may be filled with choke inserts 14. As shown in FIG. 7, but applicable to all embodiments, the lower part of the L shape of the choke rings 18 has a width W, indicated as W₁ and W₂. These widths, and the widths of additional choke rings, may be the same or they may be different. In general, the width W of the choke ring along the shaft 30 affects the attenuation, and may be specifically tuned to do so, although attenuation will occur regardless of the width. The low-impedance zones 24 adjacent to shaft 30 may be separated by high-impedance zones 22, also adjacent shaft 30, and these alternating zones contribute to the attenuation of microwaves along the shaft 30.

For example, greater attenuation is achieved when the width W is ¼ of the wavelength of the microwaves in the chamber 40. However, by using different widths W₁, W₂, etc., the assembly may be tuned to attenuate energy over a broader range of frequencies. This is true for other embodiments as well, such as those that do not have choke rings/elements with an L-shaped profile.

As shown in FIGS. 2 and 3, the mount choke ring 12 may be mounted or attached to the side of the chamber 40 with a mounting flange 11, which may add rigidity, and which may also include seals 17, which seal the shaft 30, and prevent or reduce the entry of material in the chamber 40, excluding it from contaminating or interfering with the performance of the assembly 10. FIG. 2B is an alternate embodiment of FIG. 2A—the embodiments are substantially similar, except the embodiment of FIG. 2B has a microwave-transparent seal carrier 28 which allows for easier removal and cleaning of the seals 17. The seal carrier 28 also reduces the risk of arcing between shaft 30 and the seal housing. The seal carrier 28 may be made of any suitable microwave-transparent material, such as PTFE.

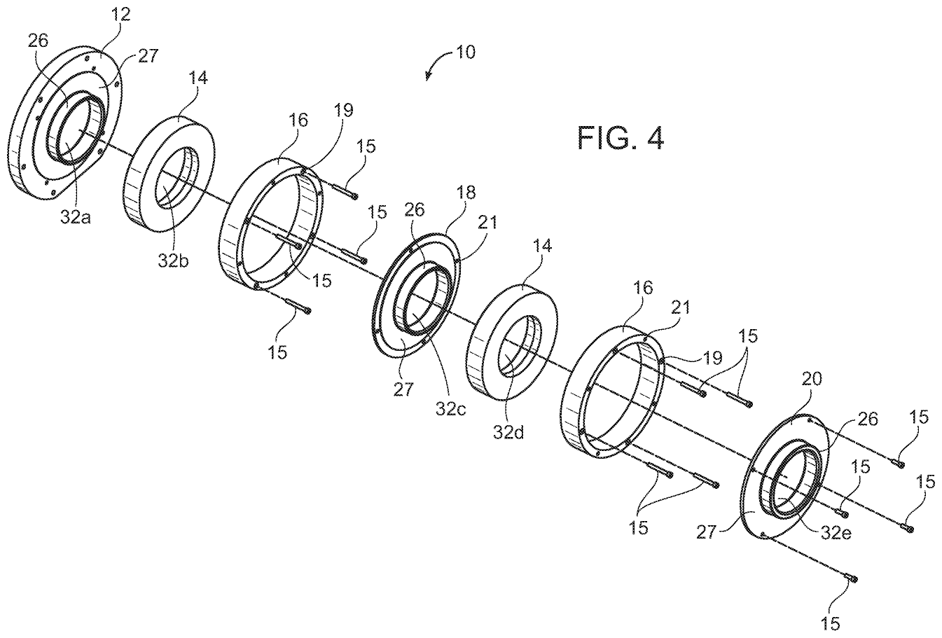

In some example embodiments, the choke rings 18, choke spacer rings 16, and choke inserts 14 may be interchangeable. In other words, there may be little or no difference between these parts, so that the assembly 10 is modular. As shown in FIG. 3, as compared to FIGS. 2A and 2B, the assembly may comprise three or more choke rings 18, and four choke inserts 14. This configuration does not require many different parts, as any choke ring 18 and choke spacer ring 16 may be assembled to any other one simply by using screws 15, since the holes of each choke spacer ring 16 will align with the holes of any other choke ring 18 and the next spacer ring 16. The countersunk screw holes 19, as shown in FIG. 2, for example, allow for the spacers rings 16 and choke rings 18 to be stacked together without interference of the screw heads protruding beyond the mating surfaces. As shown in FIG. 4, the spacers 16 and choke rings 18 may also include holes 21, which are in a pattern rotated from countersunk holes 19. As can be seen, holes 21 can receive the threaded ends of screws 15, where the screws 15 are inserted in holes 19. Thus, adjacent components are rotated, in this instance, by 45°, so that a number of spacers 16 or choke rings 18 are interchangeable with others.

As discussed above, additional elements of the assembly 10 may be stacked if and whenever greater microwave attenuation is needed. Thus, the assembly 10 may have three high-impedance zones 22 as shown in FIGS. 2A and 2B, or it may have five as shown in FIG. 3. Other numbers of zones are possible as well. As also discussed above, each high-impedance zone 22 is separated from the next zone by a low-impedance zone 24, with the alternation creating greater attenuation of microwave energy. When the desired number of choke rings 18 and choke inserts 14 are assembled, the final element, choke ring cap 20, is mated to the last choke spacer rings 16 and choke ring 18 using four screws 15 as shown in FIGS. 2 and 3. Beyond the modular assembly 10, the shaft 30 may be supported rotationally by bearing 50.

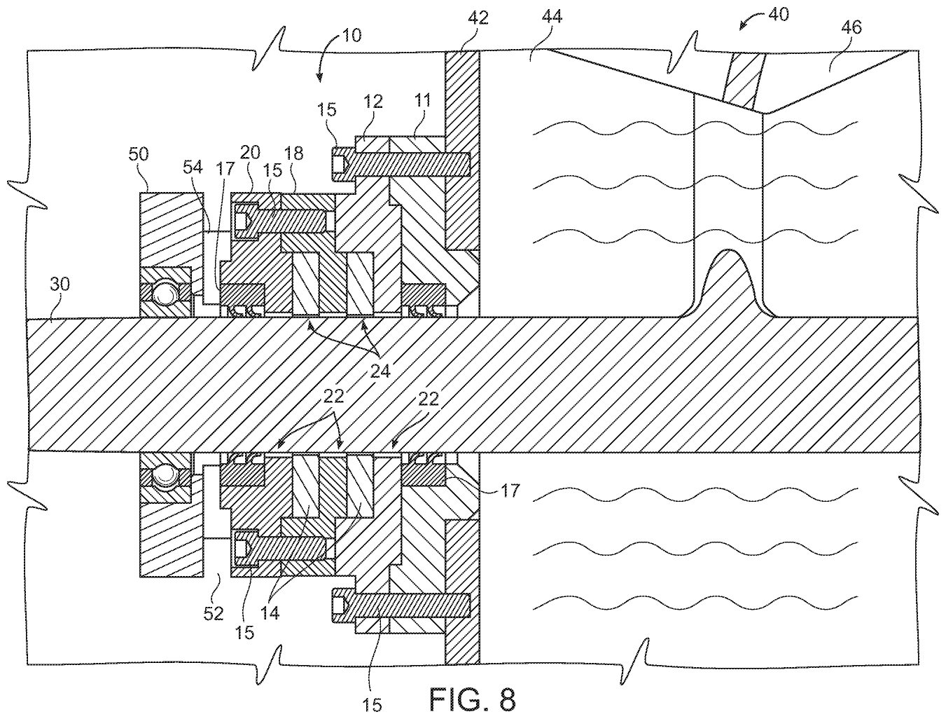

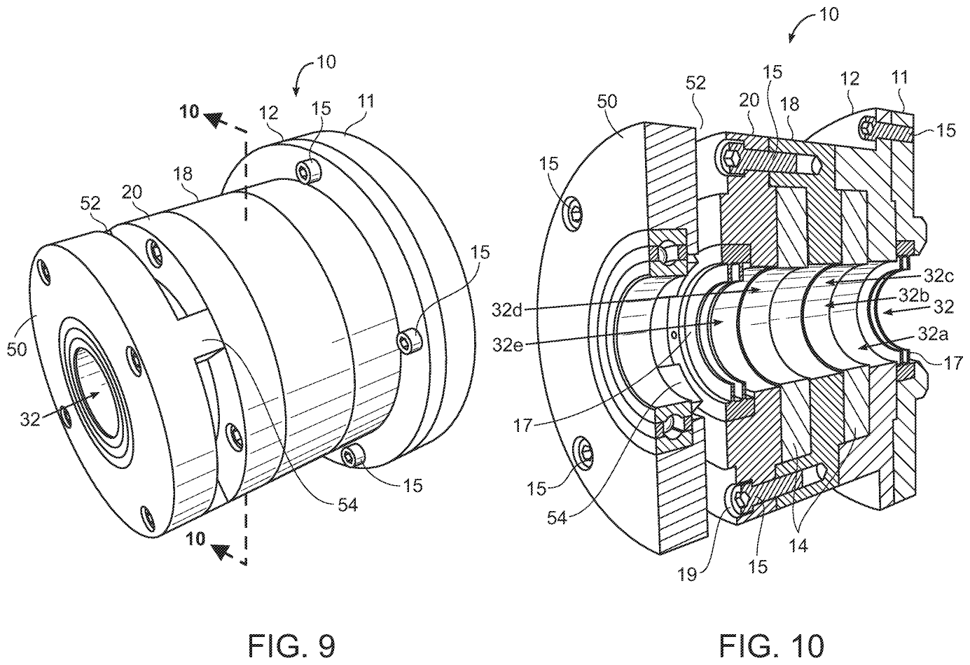

Another possible embodiment is shown in FIGS. 8-10. In this embodiment, the assembly also includes a mount choke ring 12 which creates the first high-impedance zone 22 next to the chamber 40, as with the previous embodiment. Further, the mount choke ring 12 and choke ring 18 and choke ring cap 20 do not have L-shaped flanges, but simply extend toward the opening 32 of the assembly 10 in disc form, as shown. As with other embodiments, the assembly 10 is attached to the wall 42 of chamber 40 by a mounting flange 11. Also as with other embodiments, the components of this example embodiment are modular, and so may be stacked together in different numbers to create a different number of alternating high-impedance zones 22 and low-impedance zones 24. As can be seen, the choke inserts 14 in FIGS. 8 and 10 have a different, simpler shape than those of the previous embodiment, but still define substantially rectangular cross section shapes, which in three dimensions are in the shape of flattened rings.

This embodiment does not require separate spacers as with the embodiments of FIGS. 2A and 2B, but instead relies on the shape of the choke rings 18 to create the cavity into which choke inserts 14 are positioned. This embodiment also includes a number of seals 17, the first being positioned within an annular channel in mounting flange 11 as shown in FIGS. 8 and 10. A second seal 17 may be positioned in another channel in choke ring cap 20 to prevent material from leaking past the end of the assembly 10.

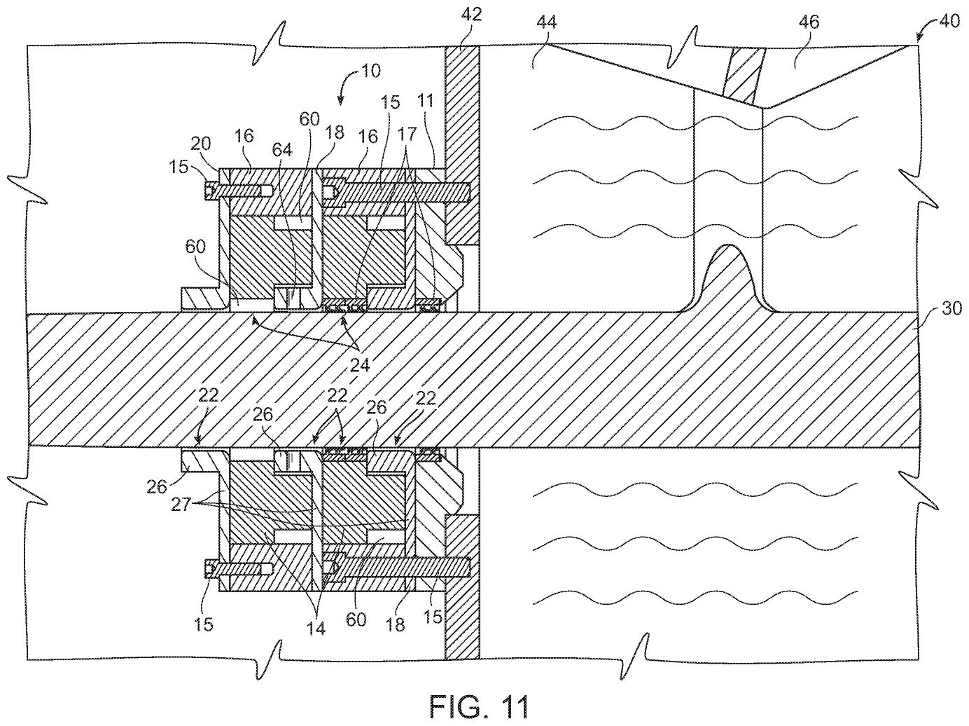

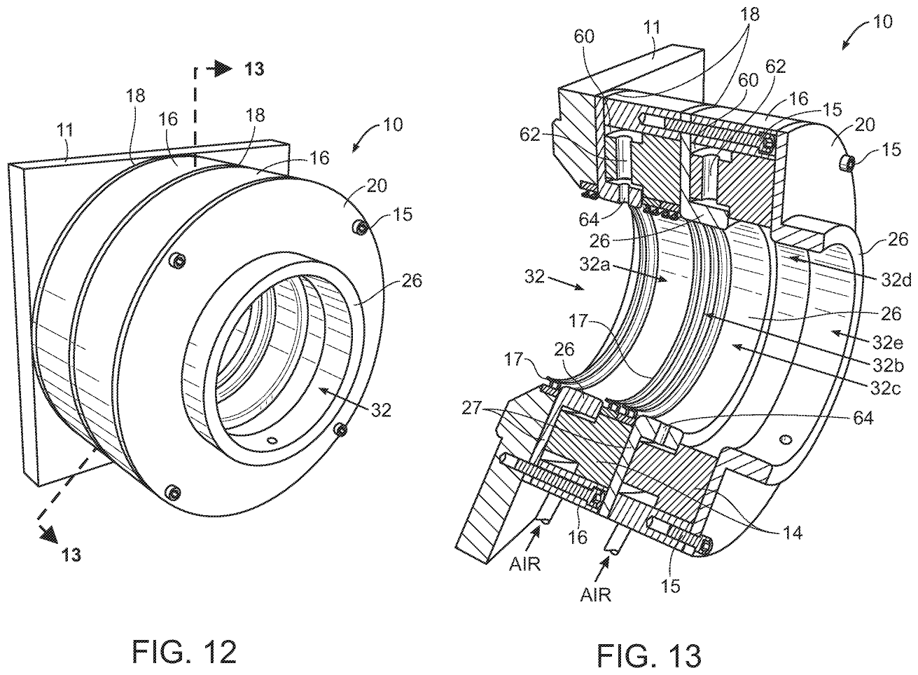

This embodiment also includes an integral bearing 50, which is attached and mounted on the assembly 10 by screws 15 that pass through bearing spacers 54, which create a gap 52 between the bearing 50 and the choke ring cap 20. This gap 52 allows any material that gets past the seals 17 to fall into the gap, preventing contamination of the bearing 50. As with other embodiments, the width of the portion of choke rings 18 next to the shaft 30 may be selected and specifically tuned to attenuate microwaves of any particular frequency, and may also be varied for different rings 18 in the assembly to attenuate different frequencies of microwaves from one zone to another. This may require slightly different components, such as choke inserts 14 having different thicknesses. However, the modular nature, due to the other dimensions and mounting hole spacing, may be retained, so that different numbers of high-impedance zones 22 and low-impedance zones 24 may still be created with a minimal number of different parts, or with the same parts, such as choke rings, choke inserts, etc. Another embodiment is shown in FIGS. 11-13. As with the previous embodiments, this embodiment works the same way, generally, to attenuate microwaves that might otherwise leak from the area where a shaft exits the chamber 40 through wall 42. In this embodiment, the choke rings 18, and the choke ring cap 20, which create the high-impedance zones 22, are also L-shaped when viewed in cross section as shown in FIGS. 11 and 13, creating a flange 26 in the form of a flat ring that extends along the shaft 30, which may pass through opening 32 of the assembly 10. In this embodiment, as with one previous embodiment, the L shape, combined with the spacing between the choke rings 12, 18, and 20, creates and defines low-impedance cavities that are somewhat rectangular in shape, filled with choke inserts 14. Also as with previous embodiments, the portion of the choke rings 18 along shaft 30 has a width W, indicated as W₁ and W₂ in FIG. 7. These widths, and the widths of additional choke rings, may be the same or they may be different. In general, the width W of the choke ring along the shaft 30 affects the attenuation, and may be specifically tuned to do so.

In this embodiment, the first choke ring 18 of the assembly 10, which is shown mounted on a mounting flange 11, is the same as subsequent choke rings, unlike previous embodiments where the mount choke ring 12 was slightly different than the intermediate choke rings 18. As best shown in FIGS. 11 and 13, the mounting flange 11 has an annular channel for accepting and holding a seal 17 to keep material out of the modular microwave choke assembly 10 by sealing the rotating shaft 30.

This embodiment may also include separate choke spacer rings 16 which, in conjunction with choke rings 18, creates substantially rectangular cavities (which have the same shape as the choke inserts) in which are positioned choke inserts 14. The choke inserts may be sized so that there is a gap between the interior face and the shaft 30, so that additional seals 17 may be positioned between the choke insert 14 and the shaft 30. FIGS. 11 and 13 show one such seal, in the choke insert closest to the chamber 40.

The choke rings 18, choke spacer rings 16, and choke inserts 14 may be interchangeable, so that the assembly 10 is modular. As with other embodiments, different numbers of choke rings 18 and choke inserts 14 may easily be assembled to create more or less microwave attenuation, as needed, with a minimum of difficulty and different parts needed, as described above. As with other embodiments, any choke ring 18 and choke spacer ring 16 may be assembled to any other one simply by using screws 15, since the holes of each choke spacer ring 16 will align with the holes of any other choke ring 18 and the next spacer ring 16.

The choke inserts 14 may be sized and shaped to create annular gaps 60 between the choke spacer rings 16 and the outer surfaces of choke ring flanges 26. In addition, the spacer rings 16 may have fittings for compressed air to be applied, as shown in FIG. 13. Holes 62 in the choke inserts 14 allow for the passage of compressed air from the inlets through the annular gaps 60, holes 62, and holes 64 that pass through the choke ring flanges 26. Accordingly, compressed air may be used to keep the shaft 30 and the modular microwave choke assembly 10 free of powder or other material being processed in the mixer.

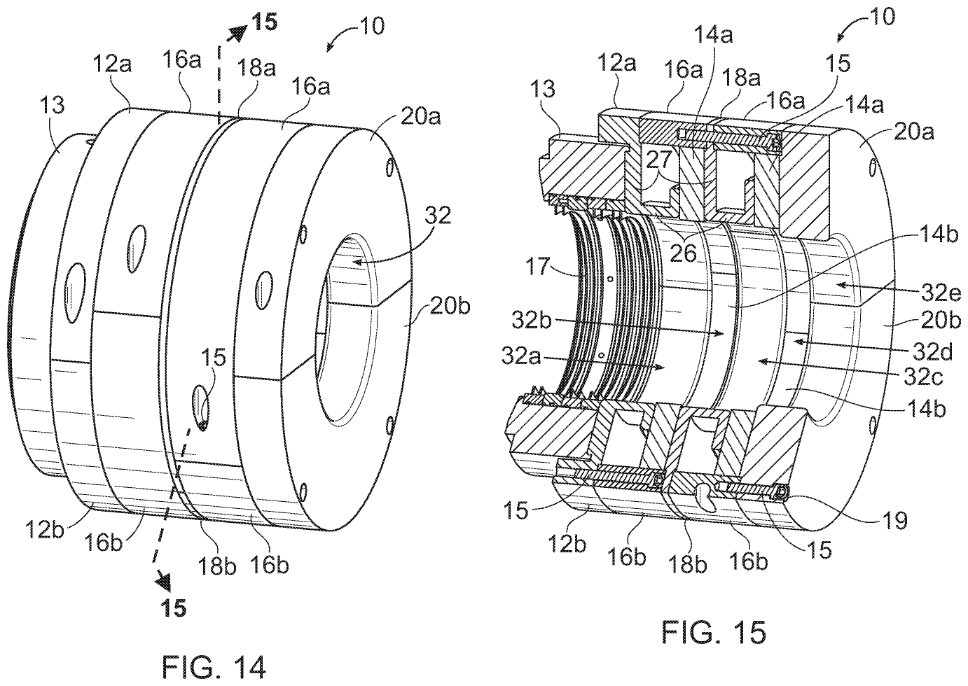

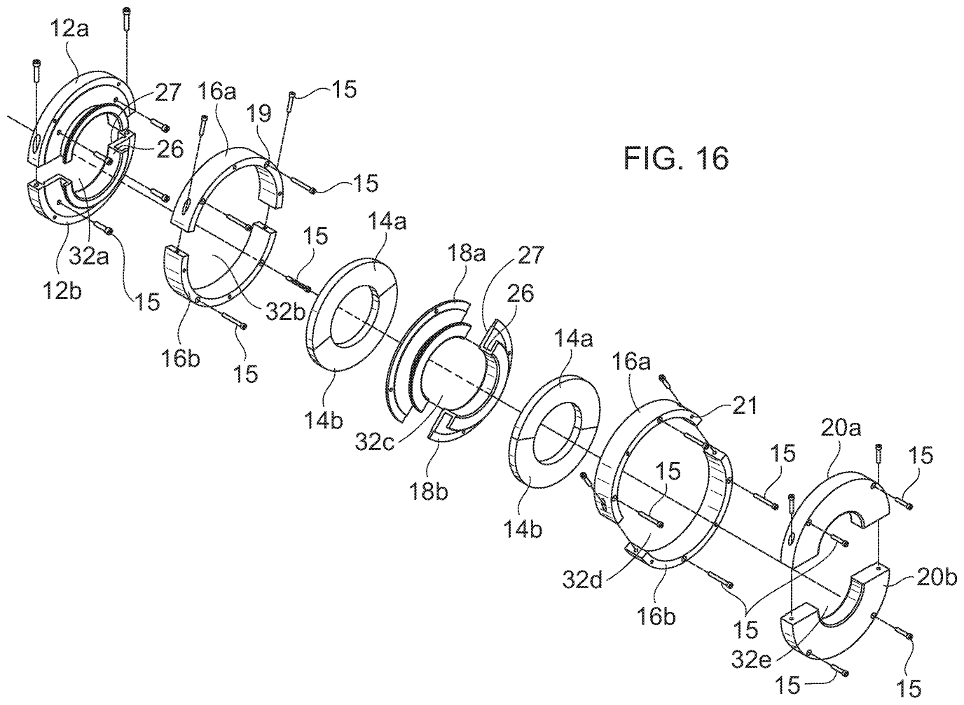

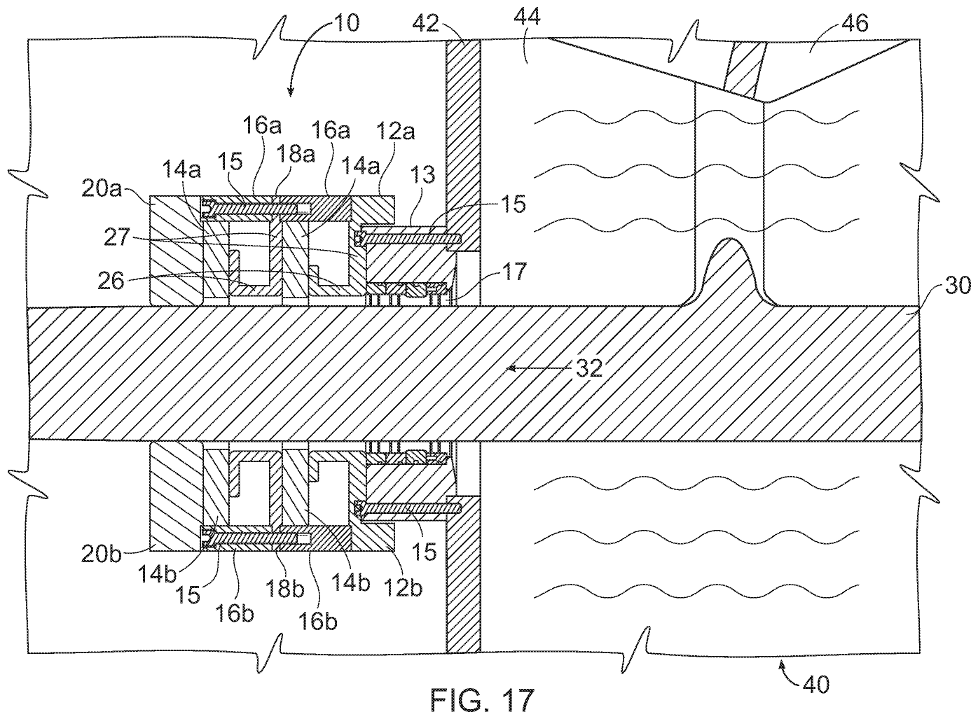

Another example embodiment of the modular assembly 10 is shown in FIGS. 14-17. In this embodiment, the element numbers in the previous embodiments generally correspond to elements shown, except that each element of the modular choke ring assembly 10 is split into an upper and lower half or part. For example, instead of a solid choke insert 14 as described above, the split assembly may comprise an upper insert 14a (or “upper part”) and a lower insert or lower part 14b. In the embodiment shown, especially as illustrated by FIG. 15, the choke inserts 14a and 14b create low-impedance zones 24, as with other embodiments. However, as also shown, the choke inserts 14a and 14b serve to prevent powder or other unwanted substances from entering the cavities created by the shape of the choke components, such as mount choke rings 12a and 12b, internal choke rings 18a and 18b, (comprising upper and lower halves, respectively) for example.

The entire cavity in this embodiment is not necessarily filled by the choke inserts, instead being left empty in this embodiment, due to the choke ring's “U” shape as shown. At the end of the assembly 10 the farthest away from the chamber, there is an upper choke ring cap 20a and a lower choke ring cap 20b, which can be held together with screws that are generally normal to the plane of the split between the components. Due to the configuration of this embodiment, both the mount choke ring and the choke ring caps are shaped differently from the internal choke rings halves or parts 18a and 18b. However, the screw hole patterns are compatible with the other components, so that the entire assembly 10 is still modular. In other words, as with other embodiments, as many additional choke ring parts 18a, 18b as are desired can be installed between the ends of the assembly whenever greater attenuation of microwave energy is desired.

Similarly, the embodiment may further comprise an upper mount choke ring 12a and a lower mount choke ring 12b, which can be held together by screws 15. Once assembled, the mount choke ring, acting as a unit, can be screwed or bolted onto mount ring 13 that is in turn mounted on the side of the chamber 40. As shown for example in FIG. 15, the mount ring 13 need not be split, and may also comprise a channel for containing seals 17 to prevent material in the chamber 40 from entering or contaminating the choke assembly 10. Further, as with another example embodiment, the split assembly embodiment may comprise a number of choke spacer rings 16a and 16b, which can also be screwed together as shown to effectively create a single spacer ring for each ring 16a and 16b.

When assembled on a shaft with a separate bearing 50, as shown for example in FIG. 1, the split embodiment has the advantage of allowing for the removal of the entire modular choke assembly 10 for cleaning, service, or to add additional choke rings, for example, without removing the bearing 50 or the shaft 30. Since the split components, once screwed securely together perform as the solid pieces (e.g., spacers, choke rings, inserts, etc.) in the previous embodiments, the split embodiment may also employ different features of the previous embodiments while retaining the advantage of being readily removed from a shaft 30 and chamber 40 without disturbing the rest of the apparatus.

### C. Operation of Preferred Embodiment

In use, the modular microwave choke assembly 10 may be used for sealing a shaft 30, such as a cylindrical, rotating shaft, or other protrusion that extends through the wall of a microwave chamber 40, to contain the microwaves in cavity 44 within the chamber 40, or reduce its strength to safe levels where the shaft 30 extends through the wall 42. The assembly may be used, for example, to seal the shaft 30 of a horizontal mixer that also uses microwaves to dry powder or other material being processed, in addition to other uses. As shown in FIGS. 8 and 11, for example, the shaft 30 may be connected to mixing paddles 46 or other agitating elements 46, to improve processing of materials by exposing them to microwaves from the cavity 44 in the chamber 40, in addition to mixing action, and possibly a vacuum, all at the same time. The shaft 30 may be connected to a motor or drive assembly (not shown) at either end of the chamber 40. The shaft 30 may pass through both ends of the chamber, supported rotationally by bearings, and sealed by a modular microwave choke assembly 10 where the shaft passes through the chamber wall 42 at each side of the chamber 40.

The modular microwave choke assembly 10 attenuates or reduces microwave leakage from the internal cavity of chamber 40 where the shaft passes through the cavity at either end. The modular microwave choke assembly 10 thus helps maintain safe levels of microwave leakage from the microwave cavity of chamber 40 where personnel may be present.

The assembly has an alternating series of zones 22, 24, that present high impedance and low impedance to microwaves along the length of the shaft 30. For example, the choke rings 18 may generally be made of metal, such as brass or stainless steel, which presents high impedance to microwaves, creating high-impedance zones 22. In contrast, choke inserts 14 may be made of Teflon, such as PTFE, which presents low impedance to microwaves, thus creating low-impedance zones 24.

The modular microwave choke assembly may comprise a central opening 32 through which the shaft 30 passes, from one end near the chamber 40, to the opposite end. Due to the alternating impedance zones 22 and 24, microwave energy is reduced more as it passes each zone, so that there is less energy present as the distance away from the chamber 40 increases. Thus, if measurements or calculations indicate that more microwave attenuation is needed, more alternating zones 22, 24 can be added in the space between the assembly 10 and the bearing 50.

As shown, for example in FIG. 1, ample space along shaft 30 is present between the choke ring cap 20 and the bearing 50, so that additional choke rings and choke inserts may be added as needed to further reduce or attenuate microwave energy. This is also true of the embodiment shown in FIG. 8, which has an integral bearing 50 attached to the modular microwave choke assembly 10. In other words, more choke rings and inserts can readily be installed between the chamber 40 and the integral bearing 50, which will simply lengthen the assembly 10 along the shaft 30.

The assembly 10 may include any number of seals along the shaft 10, which are used to keep powder or other materials within mixing chamber 40 from entering the assembly and interfering with the performance of the modular microwave choke assembly 10. The choke inserts 14 also help to keep powder from entering the assembly. To create low-impedance zones 24, the cavities formed by the spacing between choke rings could simply be left empty, but that would allow powder or other substances to enter the cavities, which could possibly affect performance, depending on the material. In addition, the material in the cavities, represented by inserts 14, also attenuates microwaves since it will tend to slow them.

Unless otherwise defined, all technical and scientific terms used herein have the same meaning as commonly understood by one of ordinary skill in the art to which this invention belongs. Although methods and materials similar to or equivalent to those described herein can be used in the practice or testing of the modular microwave choke assembly, suitable methods and materials are described above. All publications, patent applications, patents, and other references mentioned herein are incorporated by reference in their entirety to the extent allowed by applicable law and regulations. The modular microwave choke assembly may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A modular choke assembly for attenuating microwaves, comprising:
a first choke ring having a first central opening, the first choke ring positioned and shaped to surround a portion of a shaft that extends out of a microwave chamber, wherein the first choke ring creates a first high-impedance zone adjacent to the portion of the shaft surrounded by the first choke ring; and
a second choke ring mounted in a fixed position relative to the first choke ring, the second choke ring having a second central opening sized and being shaped to surround a portion of the shaft that is spaced apart from the portion of the shaft surrounded by the first choke ring, wherein the second choke ring creates a second high-impedance zone adjacent to the portion of the shaft surrounded by the second choke ring;
wherein the first high-impedance zone is separated from the second high-impedance zone by a low-impedance zone.

2. The modular choke assembly of claim 1, further comprising a mount choke ring mounted on the side of a microwave chamber, wherein the mount choke ring comprises a third central opening, the mount choke ring positioned and shaped to surround a portion of the shaft, wherein the mount choke ring creates a third high-impedance zone adjacent to the portion of the shaft surrounded by the mount choke ring.

3. The modular choke assembly of claim 2, further comprising a cavity between the first choke ring and the mount choke ring, wherein the cavity creates a second low impedance zone.

4. The modular choke assembly of claim 3, further comprising a cavity between the first choke ring and the second choke ring, wherein the cavity creates the low impedance zone.

5. The modular choke assembly of claim 1, wherein the second choke ring is connected to the first choke ring.

6. The modular choke assembly of claim 1, further comprising a cavity between the first choke ring and the second choke ring.

7. The modular choke assembly of claim 1, wherein the first choke ring and the second choke ring each comprise flange portions that surround the shaft.

8. The modular choke assembly of claim 1, wherein the first choke ring and the second choke ring are interchangeable.

9. The modular choke assembly of claim 1, further comprising a cavity between the first choke ring and the second choke ring, wherein the cavity contains an insert, and wherein the cavity creates the low impedance zone.

10. A modular choke assembly for attenuating microwaves, comprising:
a plurality of choke rings connected together, the plurality of choke rings positioned and shaped to surround a portion of a shaft that extends out of a microwave chamber, wherein each choke ring creates a high-impedance zone adjacent to the portion of the shaft surrounded by each choke ring, wherein the plurality of choke rings are spaced apart from each other along the shaft; and
a plurality of gaps between the plurality of choke rings, along the shaft, wherein the gaps are created by the spaces between the plurality of choke rings;
wherein the choke rings and the gaps create alternating high-impedance and low-impedance zones along the shaft that attenuate microwave energy.

11. The modular choke assembly of claim 10, further comprising a plurality of cavities between the plurality of choke rings, wherein the cavities create low impedance zones.

12. The modular choke assembly of claim 11, further comprising:
a plurality of inserts, wherein each insert is positioned in a cavity; and
a plurality of seals positioned in the modular choke assembly to prevent material from moving along the shaft.

13. The modular choke assembly of claim 10, wherein each choke ring comprises a flange portion adjacent to the shaft, wherein each flange portion creates a high-impedance zone along the shaft.

14. The modular choke assembly of claim 10, wherein a plurality of choke rings are physically interchangeable.

15. The modular choke assembly of claim 10, further comprising a plurality of spacers positioned between the plurality of choke rings.

16. The modular choke assembly of claim 10, further comprising a mount choke ring mounted on the side of a microwave chamber, wherein the mount choke ring is positioned and shaped to surround a portion of the shaft, wherein the mount choke ring creates a high-impedance zone adjacent to the portion of the shaft surrounded by the mount choke ring, and wherein the mount choke ring is connected to one of the plurality of choke rings.

17. The modular choke assembly of claim 10, wherein each of the plurality of choke rings comprises an upper part and a lower part, wherein each upper part is removably connected to a corresponding lower part.

18. The modular choke assembly of claim 17, wherein each choke ring of the plurality of choke rings is physically interchangeable.

19. The modular choke assembly of claim 10, further comprising a bearing that rotatably supports the shaft.

20. The modular choke assembly of claim 10, further comprising a plurality of seals positioned in the modular choke assembly to prevent material from moving along the shaft, and a seal carrier positioned in the modular choke assembly to hold the plurality of seals.

21. A modular choke assembly for attenuating microwaves, comprising:
a plurality of choke rings connected together, the plurality of choke rings positioned and shaped to surround a portion of a shaft that extends out of a microwave chamber, wherein the plurality of choke rings further comprise an air passage hole to allow air to pass from a cavity of the choke assembly to a portion of each choke ring adjacent to the shaft;
wherein each of the plurality of choke rings comprises an upper part and a lower part, wherein each upper part is removably connected to a corresponding lower part;
wherein some of the plurality of choke rings are physically interchangeable; and
wherein each choke ring creates a high-impedance zone adjacent to the portion of the shaft surrounded by each choke ring, wherein the plurality of choke rings are spaced apart from each other along the shaft; and
a plurality of cavities defined between the plurality of choke rings, wherein the cavities create low impedance zones;
a plurality of inserts, wherein each insert is positioned in a cavity, and wherein each insert comprises an upper part and a lower part, and wherein each insert is physically interchangeable; and
a bearing that rotatably supports the shaft;
wherein the plurality of choke rings and the plurality of cavities create alternating high-impedance and low-impedance zones along the shaft, and wherein the alternating zones attenuate microwave energy.
